(19) United States
(12) Patent Application Publication
(10) Pub. No.: US 2007/0294621 A1
(43) Pub. Date: Dec. 20, 2007

(54) System and Method for Displaying Information

(75) Inventors: Mark A. Hansen, Denver, CO (US); Kevin E. Schaff, Littleton, CO (US); Mark W. Lemmons, Arvada, CO (US); Cameron A. Pope, Denver, CO (US); Kevin D. Murray, Brighton, CO (US)

Correspondence Address: BAKER BOTTS L.L.P., 2001 ROSS AVENUE, SUITE 600, DALLAS, TX, 75201-2980, US

(73) Assignee: Thought Equity Management, Inc., Denver, CO (US)

(21) Appl. No.: 11/674,364

(22) Filed: Feb. 13, 2007

Related U.S. Application Data
(60) Provisional application No. 60/804,850, filed on Jun. 15, 2006.

(51) Int. Cl. G06F 3/00

(52) U.S. Cl. 715/716

(57) ABSTRACT

A method for displaying information includes receiving input from a user and adjusting a location of a cursor within a user interface based on the input. The method also includes determining whether the user has moved the cursor into a first portion of the user interface and initiating display of video content within the first portion in response to determining that the user has moved the cursor into the first portion.

### RELATED APPLICATIONS

This application claims priority under 35 U.S.C. § 119 of provisional application Ser. No. 60/804,850, filed Jun. 15, 2006, entitled “System and Method for Viewing Video Data,” which is hereby incorporated by reference.

### TECHNICAL FIELD OF THE INVENTION

This invention relates in general to information systems, and more particularly, to a method and system for retrieving and presenting time-based media content to users.

### BACKGROUND OF THE INVENTION

The rapid expansion of the Internet and a growing number of content providers has made it possible for users to easily access an unprecedented amount of media content over the Internet. While having access to such a large volume of content provides significant benefits to users, sorting through this content to find certain types of content can be an incredibly time-consuming task. For example, companies selling video footage offer online customers the opportunity to view and purchase video showing a desired subject or relevant to a desired topic. Sifting through the large libraries offered by these companies, however, can be a daunting task.

### SUMMARY OF THE INVENTION

In accordance with the present invention, the disadvantages and problems associated with information systems have been substantially reduced or eliminated. In particular, methods and systems are disclosed that provide time flexible techniques for expanding the quantity and type of content available to users, and enabling large amounts of media content to be efficiently and effectively managed and stored.

In accordance with one embodiment of the present invention, a method for displaying time-based media includes receiving input from a user and adjusting a location of a cursor within a user interface based on the input. The method also includes determining whether the user has moved the cursor into a first portion of the user interface and initiating display of time-based media within the first portion in response to determining that the user has moved the cursor into the first portion.

In accordance with one embodiment of the present invention, a system for displaying time-based comprises a display module, an input device, and a processor. The display module is capable of displaying a user interface that includes a plurality of display portions. The input device is capable of receiving input from a user. The processor is capable of generating the user interface on the display module and adjusting a location of a cursor within the user interface based on input received from the input device. The processor is also capable of determining whether the user has moved the cursor into a first portion of the user interface and initiating display of time-based media within the first portion in response to determining that the user has moved the cursor into the first portion.

Technical advantages of certain embodiments of the present invention include the ability to review video and other time-based media more quickly by reducing the input required to initiate playback of media files and by eliminating the need for a separate media player instantiation for each media file played. Additionally, particular embodiments of the present invention may provide improved techniques for searching media archives and distributing media content. Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a particular embodiment of a system for providing time-based media content from a server to multiple clients;

FIG. 2 illustrates an example user interface that may be generated by a particular embodiment of the client shown in FIG. 1;

FIG. 3 shows executable code for an example player that may be used to display media files in a particular embodiment of the system shown in FIG. 1; and

FIG. 4 is a flowchart describing example operation of a particular embodiment of the client shown in FIG. 1.

### DETAILED DESCRIPTION OF THE INVENTION

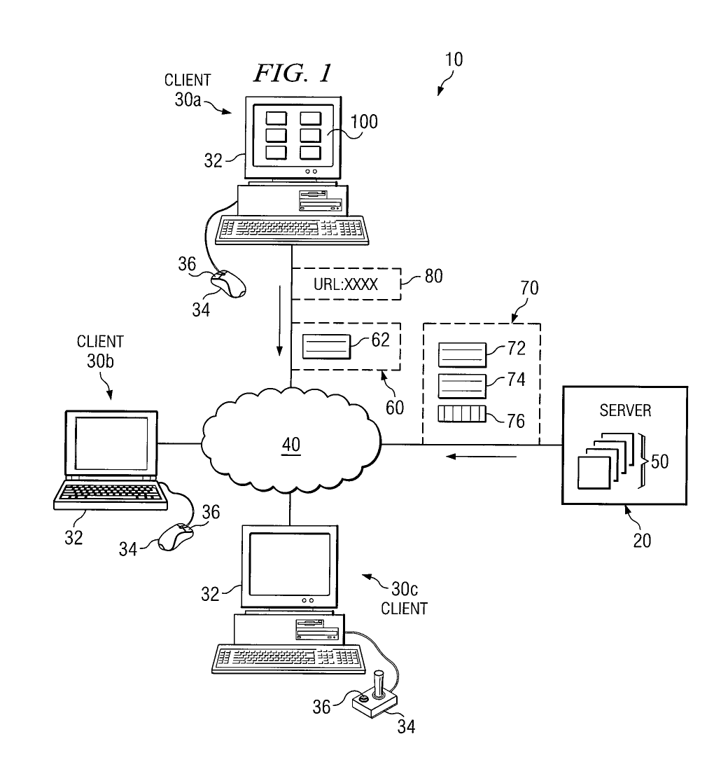

FIG. 1 illustrates a particular embodiment of a system 10 for displaying information to a user. System 10 includes a server 20, one or more clients 30, and a network 40. In response to requests for time-based media content, server 20 provides content to clients 30, which then display the content to users operating clients 30. As described in greater detail below, clients 30 are capable of displaying the received content in a manner that allows users to review the content quickly and efficiently. As a result, in particular embodiments, users utilizing clients 30 may be capable of rapidly reviewing a large amount of content, such as several media files, to select content for purchase, further review, and/or other purposes.

Server 20 receives requests for media content from client 30 and facilitates the transmission of media content to clients 30. In particular embodiments, such as the embodiment shown in FIG. 1, server 20 represents a web server that stores media files 50 available for request by clients 30. Although FIG. 1 illustrates, for the purpose of simplicity, an embodiment of system 10 in which server 20 stores media files 50 locally, in alternative embodiments other devices within system 10 may store media files 50 or other media content, and server 20 may request content from those devices as appropriate in responding to requests from clients 30. In general, server 20 may represent any appropriate collection of hardware and/or software suitable to provide the described functionality.

Clients 30 display content to users retrieved from server 20 or devices in system 10. Clients 30 represent any device appropriate to receive input from a user and to display media content to the user based on the received input. Examples of clients 30 may include, but are not limited to, computers, interactive televisions, video-enabled telephones, and portable communication devices. More generally, however, clients 30 may include any appropriate combination of hardware and/or software suitable to provide the described functionality. Although FIG. 1 illustrates a particular number and type of clients 30, alternative embodiments of system 10 may include any appropriate number and suitable type of clients 30. In the example embodiment illustrated in FIG. 1, clients 30 each include a display module 32, an input device 34, and a processor.

Display module 32 comprises any hardware and/or software suitable to allow client 30 to display text, graphic, video, audio, animation and/or other forms of time-based media to a user of the corresponding client 30. Display module 32 may represent a part of client 30 and/or may be coupled to client 30 in a manner suitable to allow client 30 to transmit content to display module 32 for display on or by display module 32. Examples of display module 32 may include, but are not limited to, a computer monitor, a display on a portable communication device, speakers, and/or headphones.

Input device 34 represents any appropriate hardware and/or software to allow a user to provide input to a particular client 30 and may represent one or more physically discrete components. Input device 34 may represent a part of client 30 and/or may be coupled to client 30 in a manner suitable to allow input device 34 to transmit information input from a user to client 30. Input device 34 may allow the user to input information to adjust the position of a cursor, define search criteria 62, select media files 50 to view, and/or control the operation of client 30 and other devices within system 10. Examples of input device 34 include, but are not limited to, a mouse, keyboard, joystick, touchpad, scroll wheel, and/or rollerball. Additionally, in particular embodiments, input device 34 may include a device button 36 by which the user can select or activate items displayed on display module 32.

Network 40 represents any form of communication network supporting circuit-switched, packet-based, and/or any other suitable type of communication. Although shown in FIG. 1 as a single element, network 40 may represent one or more separate networks, including all or parts of various different networks that are separated and serve different groups of clients 30. Network 40 may include routers, hubs, switches, gateways, bridges, and/or any other suitable components in any suitable form or arrangement. In general, network 40 may comprise any combination of public or private communication equipment such as elements of the public-switched telephone network (PSTN), a global computer network such as the Internet, a local area network (LAN), a wide-area network (WAN), or other appropriate communication equipment.

Media files 50 represent time-based media that may be displayed, played, or otherwise presented by clients 30. As used in this description and the claims that follow, “time-based media” refers to any form of content, data, and/or information that provides a time-varying visual, aural, and/or sensory experience when read, played, and/or displayed by an appropriate media player. Examples of “time-based media” include, but are not limited to, video, film, stop-motion imagery, animation, and other types of motion imagery; speech, music, sounds, and other forms of audio information and any combinations thereof. In particular embodiments, media files 50 represent Flash video (.flv) files. Although the description below describes media files 50 as “files,” media files 50 may represent media content structured or transmitted in any appropriate manner. For example, media files 50 each may represent a collection of multiple content files, content streamed to a client, content transmitted to client as a series of packets or frames, and/or content structured and transmitted in any appropriate manner. Moreover, although the description below focuses on embodiments in which only video content is displayed to users, alternative embodiments may be configured to display any form of time-based media content to users of clients 30.

In operation, a client 30 (for purposes of this example, client 30a) requests video content from server 20. Client 30a may request video content in any appropriate manner based on the configuration and capabilities of client 30a and server 20. In particular embodiments, client 30a transmits a search request 60, such as a Hypertext Transport Protocol (HTTP) request, identifying or describing the requested video content to server 20. In particular embodiments, search request 60 may include search criteria 62 that specify the content client 30a is requesting. Search criteria 62 may represent specific filenames, keywords, content categories (e.g., public domain content), content format properties (e.g., picture quality criteria), source requirements (e.g., criteria specifying certain content providers), and/or any other suitable criteria that the user may utilize to describe the desired content to server 20.

In response to search request 60, server 20 identifies one or more requested media files 50 that satisfy search request 60. For example, as noted above, search request 60 may include search keywords associated with content requested by client 30a. In response to such a search request 60, server 20 may search a database of media files 50 maintained by server 20 (or another device in system 10) and identify one or more media files 50 that are associated with the search keywords based on filenames, tags associated with the media files 50, and/or other information identifying or describing the content of the relevant media files 50.

After identifying the requested media files 50, server 20 communicates to client 30a a search response 70 specifying, directly or indirectly, the identified media files 50. In particular embodiments, search response 70 includes a player 72, parameters 74, and file identifiers 76. Player 72, parameters 74, and file identifiers 76 may be transmitted to client 30, for example, as part of a webpage.

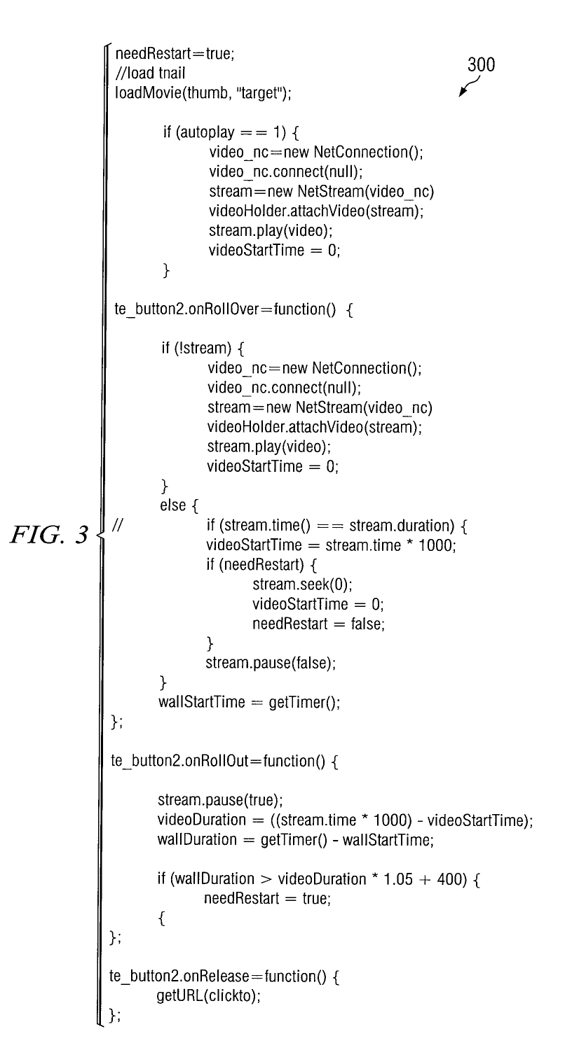

Player 72 comprises instructions capable, when executed, of playing video, audio, and/or multimedia files received from server 20. In particular embodiments, player 72 comprises an object representing a Flash project. The object is capable of receiving HTML (or other forms of markup) as a specific input and playing, pausing, and/or restarting Flash Media file (.flv) or other forms of media files 50. In particular embodiments, this object or “holder file” may be dynamically associated with and capable of playing all media files identified by search response 70. As a result, client 30 may only need one player 72 and may only need to load that player 72 once to play any or all of the media files 50 identified by search response 70. FIG. 3 illustrates the instructions included in an example embodiment of player 72.

Parameters 74 specify characteristics of media files 50 that satisfy search request 60. In particular embodiments, server 20 may communicate a separate set of parameters 74 for each of the media files 50 identified by server 30. Parameters 74 may include, but are not limited to, the location (e.g., in the form a Uniform Resource Locator (URL)), resolution, frame size, and aspect ratio of each identified media file 50.

File identifiers 76 are each associated with a particular media file 50 identified by server 20 in response to search request 60 and include information by which a user can identify the corresponding media file 50. As a result, the user may utilize file identifiers 76 to select media files 50 for viewing. File identifiers 76 may represent text, graphics, and/or forms of information suitable to allow a user to identify the corresponding media file 50 or determine its contents. In particular embodiments, file identifiers 76 each represent a thumbnail representation of the initial frame of their corresponding media file 50.

In response to receiving search response 70, client 30 generates a user interface 100 on display module 32. As part of generating user interface 100, client 30 loads player 72. As noted above, player 72 may represent Flash code capable of playing any of the media files 50 identified by parameters 74. In particular embodiments, client 30 loads player 72 by executing instructions associated with player 72 and/or transferring executable code associated with player 72 to a cache for subsequent execution or use by client 30. Moreover, in particular embodiments, client 30 loads player 72 only once for all media files 50 identified by server 20 in response to search request 60. As discussed in further detail below, this player 72 may be capable of playing any of the identified media files 50 in a particular area of a user interface that is associated with that particular media file 50.

In addition, user interface 100 displays or references file identifiers 76 provided by server 20. Each file identifier 76 is associated with a particular media file 50 and identifies the corresponding media file 50 to the user. For example, in particular embodiments, each file identifier 76 comprises a thumbnail representation of a frame of the corresponding media file 50.

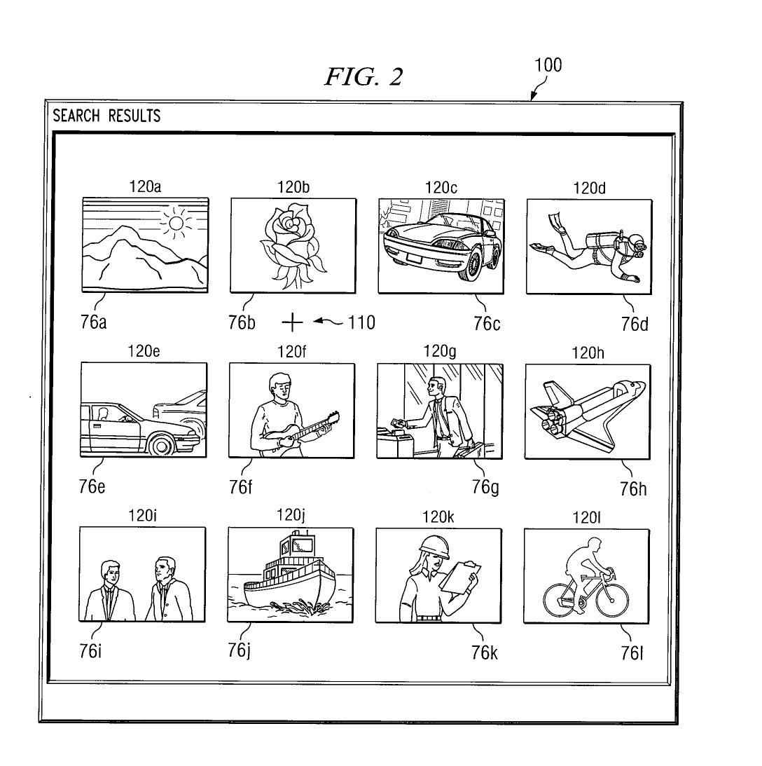

The user may then select, from the group of media files 50 identified by server 20, a particular media file 50 for viewing. In particular embodiments, the user may select a particular media file 50 by moving a cursor displayed in user interface 100 over the file identifier 76 associated with the desired media file 50. An example of this selection process is described in greater detail below with respect to FIG. 2.

In response to the user selecting a media file 50, client 30a requests the selected media file 50 from server 20. Client 30a may request the selected media file 50 in any appropriate manner based on the configuration and capabilities of client 30a and server 20. In the illustrated embodiment of system 10, client 30a transmits a content request 80 identifying the selected media file 50. For example, in particular embodiments, parameters 74 include URLs specifying the location of all of the identified media files 50, and client 30a transmits an HTTP request to server 20 that includes the URL of the selected media file 50.

In response to receiving content request 80, server 20 transmits the selected media file 50 to client 30a. Server 20 may transmit the requested media file 50 to client 30a in any suitable manner. For example, server 20 may transmit the selected media file 50 to client 30a as a complete file, a progressive download, or as a video stream, or any other from of transmission. At an appropriate point after client 30a begins receiving the selected media file 50, client 30a may initiate display of the selected media file 50. As discussed in greater detail below, client 30a, in particular embodiments, initiates the display in a portion of user interface 100 previously occupied by the file identifier 76 associated with the selected media file 50.

Additionally, in particular embodiments, client 30a may be configured to allow the user to simultaneously view multiple media files 50. As a result, while client 30a is playing the selected media file 50, the user may select a second media file 50. In particular embodiments, the user may select the second media file 50 by moving a cursor shown in user interface 100 to a portion of user interface 100 that contains a file identifier 76 associated with a second media file 50. Client 30a may then transmits a second content request 80 to server 20. In response to the second content request 80, server 20 transmits a second selected media file 50 to client 30a. Depending on the configuration of client 30a, the user may also provide additional information instructing client 30a to continue playing the first selected media file 50 despite the repositioning of the cursor.

At an appropriate point after receiving the second selected media file 50, client 30a may begin playing the second selected media file 50. In particular embodiments, client 30a plays the second selected media file 50 using the same player 72 as client 30a uses to play the first selected media file 50. Additionally, player 72 may begin playing the second selected media file 50 while the first selected media file 50 is still playing. Consequently, player 72 may be capable of playing multiple different media files 50 at the same time.

Thus, in particular embodiments, client 30 can load a single player that is dynamically associated with, and capable of playing, a plurality of different media files 50. As a result, clients 30 can initiate playback of any of the media files 50 without needing to instantiate a separate player for each selected media file 50 or without requiring the user to click through to a separate webpage that includes a player dedicated to the selected media file 50. This may dramatically reduce the time required for a user to review a large number of video clips.

Furthermore, in particular embodiments, the player 72 included in search response 70 comprises instructions in a language, such as Flash, that has widespread support among browsers used by clients 30. Consequently, player 72 can be provided seamlessly to a wide variety of different clients 30 and a user's review of the media files 50 provided by server 20 is not limited by the standalone players installed on the user's client 30. Thus, particular embodiments of system 10 may provide a number of operational benefits. Alternative embodiments, however, may provide all, some, or none of these benefits.

In addition, the described functionality may be implemented in a variety of different types of systems 10. As noted above, in particular embodiments, system 10 may represent a video search system for reviewing and purchasing video footage. In such embodiments, the user may provide search criteria 62 to server 20 and server 20 may search a database of video footage or other motion imagery to identify media files 50 that satisfy the search criteria 62. The user may then play any of the identified media files using player 72. In particular embodiments, system 10 may be configured to allow the user to purchase the selected media file 50 by, for example, double-clicking a thumbnail or other file identifier 76 associated with the selected media file 50. By allowing the user to play any and all of the media files 50 in the search results with a single player 72, system 10 may reduce the amount of time required for the user to review the search results and find a suitable media file 50. Additionally, system 10 may further reduce the amount of time required for a user to review the search results by utilizing the user interface 100 and user interface techniques described below with respect to FIG. 2.

FIG. 2 illustrates user interface 100 generated in a particular embodiment of system 10. In particular, FIG. 2 illustrates a user interface 100 that may be generated by a client 30 in response to information received from server 20. In particular embodiments, user interface 100 is generated, in part, by client 30 displaying a webpage transmitted by server 20 as part of search response 70. The example user interface 100 shown in FIG. 2 includes a cursor 110 and a plurality of display portions 120. Although FIG. 2 illustrates a specific example of a user interface 100 that may be generated in a particular embodiment of system 10, alternative embodiments may provide the described functionality using any appropriate form of user interface 100, generated and structured in any suitable manner.

Cursor 110 comprises any appropriate symbol, text character, or graphical element to mark a position within user interface 100. Client 30 moves the cursor 110 within user interface 100 based on input received from a user of client 30. For example, in particular embodiments, client 30 includes a mouse, joystick, keyboard, and/or other input device 34 that the user can use to provide client 30 location input for cursor 110. As a result, client 30 may adjust the location of cursor 110 based on input provided by the user using this input device 34.

Display portions 120 represent areas within user interface 100 that are each associated with a particular media file 50. Additionally, display portions 120 include or are otherwise associated with file identifiers 76 provided by server 20 to allow a user to identify the media file 50 associated with a particular display portion 110. In particular embodiments, such as the one illustrated in FIG. 2, each file identifier 76 comprises a thumbnail representation of one frame of the media file 50 associated with that file identifier 76. As a result, in particular embodiments, the user can identify a particular media file 50 to play based on the corresponding file identifier 76. Although FIG. 2 illustrates an embodiment in which file identifier 76 is displayed within the corresponding display portion 120 and is coextensive with the corresponding display portion 120, in alternative embodiments file identifier 76 may be located outside and/or removed from the corresponding display portion 120. For example, in particular embodiments of user interface 100, file identifier 76 may represent a text description for a particular media file 50 and may be positioned beneath the display portion 120 associated with that media file 50.

In operation, client 30 receives a player 72, file identifiers 76, and parameters 74 from server 20 as described above. In response to receiving player 72, file identifiers 76, and parameters 74 from server 20, client 30 displays user interface 100 on display module 32. In particular embodiments, player 72, file identifiers 76, and parameters 74 are transmitted with, or as part of, a webpage and client 30 generates user interface 100 by displaying the webpage. Furthermore, as part of generating user interface 100, client 30 may load player 72 by executing a portion of the code comprising player 72. As a result, in such embodiments, player 72 may then be ready to play media files 50 as soon as the user indicates a media file 50 to be played.

Once client 30 generates user interface 100, the user can indicate to client 30 one or more media files 50 to be played. In particular embodiments of system 10, client 30 monitors the position of cursor 110 and user can indicate to client 30 a media file 50 to play by moving cursor 110 into a display portion 120 associated with that media file 50. For example, in particular embodiments, each display portion 120 may include a thumbnail corresponding to a media file 50 associated with that display portion 120. The user may indicate a media file 50 to play by moving cursor 110 into the thumbnail associated with that media file 50. As a result, in particular embodiments, client 30 may, in response to determining that cursor 110 is positioned within a particular display portion 120, initiate display of the media file 50 associated with that display portion 120.

Thus, in the example illustrated in FIG. 2, the user can initiate playback of the media file 50 associated with the thumbnail 76c in display portion 120c by moving cursor 110 into display portion 120c without the user providing a selection input, such as a mouse button-click, from input device 32 (apart from positioning cursor 110). Moreover, in particular embodiments, playback can begin without any need to initiate a separate media player. As a result, by limiting the requisite user input and eliminating the need to load additional webpages or spawn separate players, system 10 can reduce the amount of time a user must spend to review media files 50. As noted above, this may be beneficial, for example, for users attempting to sort through search results to find an appropriate media file 50 for a particular use.

In addition, in particular embodiments, user interface 100 may allow the user to control other aspects of playback. For example, after the user has initiated playback of a particular media file 50 by moving cursor 110 into a display portion 120 associated with the relevant media file 50, the user may then stop playback by moving cursor 110 outside that same display portion 120. For example, in embodiments in which display portion 120 represents a thumbnailed frame from media file 50, the user may terminate playback by moving cursor 110 off the thumbnail of the media file 50 currently playing.

Furthermore, user interface 100 may allow user to initiate concurrent playback of multiple media files 50. In particular embodiments, the user may achieve this by initiating playback of a first media file 50, providing an input to client 30 instructing client 30 to continue playing the first media file 50, and then initiating playback of a second media file 50. For example, after initiating playback of a first media file 50 the user may, in particular embodiments, instruct client 30 to continue playing the first media file 50 by clicking and holding a mouse button while moving cursor 110 out of the display portion 120 associated with the first media file 50. The user may then initiate playback of a second media file 50 by moving cursor 110 into a second display portion 120 associated with a second media file 50. As a result, in particular embodiments, user interface 100 may provide additional time-saving benefits by allowing the user to simultaneously view multiple different files with a minimal amount input.

FIG. 3 shows an example of code 300 that may be used to implement player 72 in particular embodiments of system 10. More specifically, code 300 represents Flash code for a particular player 72 capable of playing Flash video (.flv) files provided by server 20. While FIG. 3 provides a specific example of one type of player 72 that may be used in particular embodiments of system 10, player 72 may, as noted above, represent code in any language or form suitable for execution on the relevant embodiment of system 10.

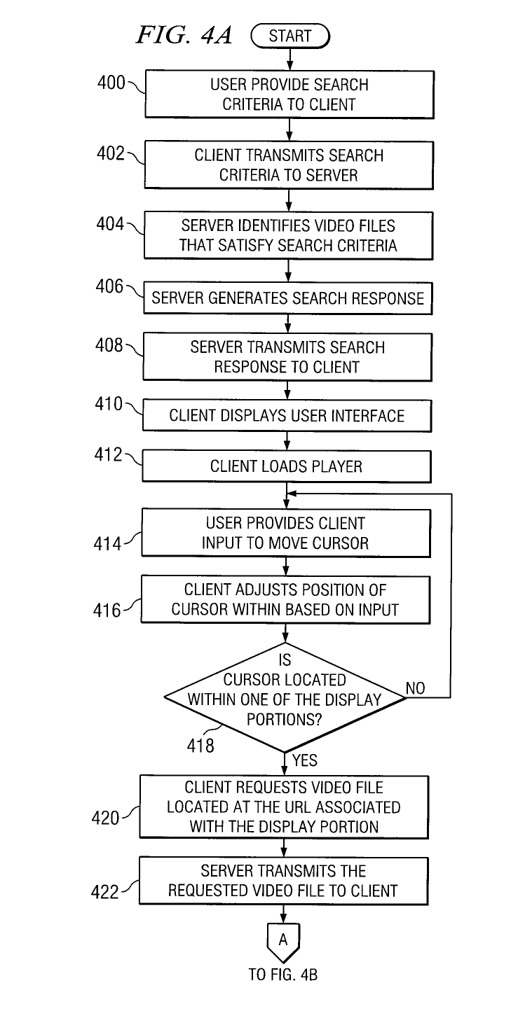

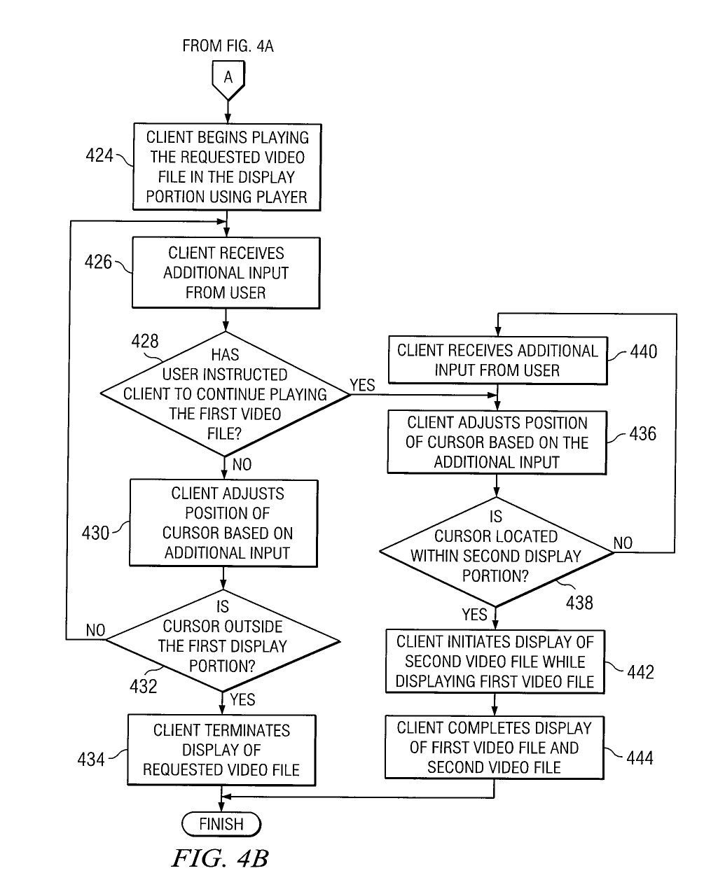

FIG. 4 is a flowchart illustrating operation of a particular embodiment of system 10 in delivering content to a user of a particular client 30. In the embodiment of system 10 described by FIG. 4, a user can provide one or more search criteria 62 to server 20 for media files 50. In response, server 20 may then provide search results to the user that identify one or more media files 50 that satisfy the search criteria 62. The user may then utilize user interface 100 to review, play, select, and/or purchase media files 50 included in the search results.

In general, the steps illustrated in FIG. 4 may be combined, modified, or deleted where appropriate. Additional steps may also be added to the example operation. Furthermore, the described steps may be performed in any suitable order without departing from the scope of the invention.

Operation begins at step 400 with the user providing search criteria 62 to client 30. As noted above, search criteria 62 may represent keywords, content categories (e.g., public domain content), content format properties (e.g., picture quality criteria), requirements for the source of the content (e.g., criteria specifying certain content providers), and/or any other suitable criteria that the user may utilize to describe the desired content to client 30. At step 402, client 30 transmits the search criteria 62 to server 20. In particular embodiments, client 30 transmits the search criteria 62 to server 20 as part of a search request 60, such as an HTTP request.

Server 20 then identifies one or more media files 50 that satisfy the search criteria 62 at step 404. As described above, in particular embodiments, server 20 is capable of searching a database of media files 50 located within system 10 and identifying media files 50 stored in the database that satisfy the search criteria 62. For example, in particular embodiments, server 20 may access a database that associates each of the stored media files 50 with one or more keywords. When server 20 receives a search request 60 that includes keywords provided by the user, server 20 identifies one or more media files 50 associated with the keywords provided by the user.

After identifying one or more media files 50 that satisfy the search criteria 62, server 20 generates search response 70 at step 406. In particular embodiments, search response 70 includes player 72, parameters 74, and file identifiers 76. At step 408, server 20 transmits search response 70 to client 30. Client 30 displays user interface 100 at step 410. As noted above with respect to FIG. 2, user interface 100 may include a plurality of display portions 120 with each display portion 120 associated with a particular file identifier 76 included in request response 70. Additionally, as part of displaying user interface 100, client 30 may load player 72 or otherwise prepare player 72 to accept video content at step 412. In particular embodiments, client 30 may only need to load player 72 this one time to play any and all media files 50 identified in the search results provided by server 20.

At appropriate points during operation of system 10, the user may provide client 30 input to move cursor 110 within user interface 100. This is illustrated in FIG. 4 at step 414. In response, client 30 adjusts the position of cursor 110 within user interface 100, at step 416, based on the input provided by the user.

In particular, the user may move cursor 110 in an effort to initiate playback of media files 50 identified by server 20. In particular embodiments, the user may initiate playback of a particular media file 50 by moving cursor 110 into a display portion associated with that media file 50. As a result, in particular embodiments, client 30 determines whether cursor 110 is located within one of the display portions 120 of user interface 100 at step 418. If cursor 110 is not located within a display portion 120 associated with any of the media files 50, operation returns to step 414 with client 30 receiving additional input from the user.

If, instead, client 30 determines that cursor 110 is located within a particular display portion 120, client 30 initiates the display of a media file 50 associated with that display portion 120. For example, in the embodiment described by FIG. 4, request response 70 includes parameters 74 that describe the media files 50 identified by server 20. These parameters may include URLs or other identifiers that specify file locations for each of the media files 50 identified by server 20. As a result, client 30 may, as part of initiating playback, request a media file 50 located at the URL associated with the relevant display portion 120. Thus, as shown in FIG. 4 at step 420, client 30 may request a media file 50 located at the associated URL from server 20 or another device in system 10 responsible for satisfying content requests 80.

Server 20 (or another appropriate device in system 10) transmits the requested media file 50 to client 30 at step 422. At step 424, client 30 begins playing the requested media file 50 using player 72. In particular embodiments, client 30 may play the requested media file 50 in the display portion 120 associated with the requested media file 50. As a result, in such embodiments, client 30 may replace a file identifier 74 (such as a thumbnail) corresponding to the requested media file 50 with a display of the requested video content.

Client 30 may continue playing the requested media file 50 until receiving further input from the user instructing client 30 to terminate playback. For example, in particular embodiments, the user may terminate playback of the requested media file 50 by moving cursor 110 out of the associated display portion 120. As a result, client 30 may be configured to receive additional input from the user, at step 426, while playing the requested media file 50. Additionally, client 30 may also be configured to allow the user to initiate concurrent playback of multiple media files 50. The user may instruct client 30 to continue playback of the first media file 50 while the user initiates playback of second media file 50. As a result, in particular embodiments, the additional input may include information instructing client 30 to continue playing the first media file 50 regardless of whether the user moves cursor 110 outside the first display portion 120. For example, in particular embodiments, the user may instruct client 30 to continue playing the first media file 50 by holding a device button 36 of an input device 34 down while moving, or “dragging,” the cursor 110 outside of the first display portion 120.

Thus, client 30 may determine, at step 428, whether the user has instructed client 30 to continue playing the first media file 50 regardless of whether the user moves cursor 110 out of the first display portion 120. As discussed above, in particular embodiments, client 30 may perform this step by determining whether the user has clicked a device button 36 of input device 34 and moved cursor 110 out of the first display portion 120 while holding device button 36 down. If so, operation continues at step 436.

If the user has not instructed client 30 to continue displaying the first media file 50, client 30 may, if appropriate, adjust the position of cursor 110 based on the additional input received from the user, at step 430. Client 30 may then determine whether the user has moved cursor 110 outside of the first display portion 120 at step 432. If not, operation returns to step 426. If, however, the user has moved cursor 110 outside of the first display portion 120, client 30 may terminate playback of the requested media file 50 at step 434. As shown in FIG. 4, operation of system 10 may then end with respect to displaying the first media file 50.

Returning to step 428, if client 30 determined at step 428 that client 30 has received input from the user instructing client 30 to continue playing the first media file 50 regardless of whether the user moves cursor 110 out of the first display portion 120, operation may continue, at step 436, with client 30 adjusting the position of cursor 110 based on the additional input received from the user during step 426. At step 438, client 30 may then determine whether cursor 110 is now located within a display portion 120 associated with a second media file 50. If not, client 30 may continue to adjust the position of cursor 110, at step 440, based on further input received from the user and return to step 436.

If client 30 determines that the position of cursor 110 is located within a second display portion 120, client 30 may, at step 442, initiate playback of a second media file 50 in a similar manner to that described above with respect to the first media file 50. As a result, the user may be able to initiate concurrent display of both the first media file 50 and a second media file 50. This may further reduce the amount of time the user must spend in reviewing a large number of search results. Playback may then continue until client 30 completes playback of both media files 50 (as shown in FIG. 4 at step 444) or playback may be terminated by additional input from the user. Operation of system 10 in displaying the first media file 50 may then end as shown in FIG. 4.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for displaying information, comprising:
receiving search criteria from a user;
identifying a plurality of media files corresponding to the search criteria;
loading a media player at a client;
displaying, within a user interface, a plurality of display portions, wherein each display portion is associated with one of the identified media files; and
playing selected ones of the identified media files in associated display portions using the loaded media player.

2. The method of claim 1, wherein playing selected ones of the identified media files:
receiving input from the user;
adjusting a location of a cursor within the user interface based on the input;
determining whether the user has moved the cursor into a first display portion of the user interface; and
initiating display of a media file within the first portion in response to determining that the user has moved the cursor into the first portion.

3. The method of claim 2, wherein initiating display of the media file within the first portion in response to determining that the user has moved the cursor into the first portion comprises initiating display of the media file within the first portion in response to determining that the user has moved the cursor into the first portion and without receiving a selection input from the user.

4. The method of claim 3, wherein:
receiving input from a user comprises receiving input from an input device comprising a device button operable to transmit a selection input; and
initiating display of the media file without receiving a selection input from the user comprises initiating display of a media file without detecting a click of the device button.

5. The method of claim 2, further comprising:
receiving additional input from the user;
adjusting the position of the cursor based on the additional input;
determining whether the user has moved the cursor out of the first portion of the user interface; and
in response to determining that the user has moved the cursor out of the first portion of the user interface, terminating display of the media file.

6. The method of claim 2, wherein the media file comprises a first media file, and further comprising:
receiving additional input from the user, wherein the additional input includes information instructing the client to continue playing the first media file;
adjusting the position of the cursor based on the additional input;
determining whether the user has moved the cursor into a second portion of the user interface; and
while continuing to display the first media file in the first portion of the user interface, displaying a second media file within the second portion in response to determining that the user has moved the cursor into the second portion.

7. The method of claim 1, wherein each of the display portions comprises a thumbnail representation of a portion of a media file associated with that display portion.

8. The method of claim 1, wherein the media files comprises motion imagery.

9. The method of claim 1, wherein the media files comprise audio information.

10. The method of claim 1, wherein:
receiving search criteria comprises receiving one or more search keywords; and
identifying a plurality of media files comprises identifying a plurality of media files associated with the search keywords.

11. An apparatus for displaying information, comprising:
a display module operable to display a user interface comprising a plurality of display portions;
an input device operable to receive input from a user; and
a processor operable to:
receive search criteria from a user;
identify a plurality of media files corresponding to the search criteria;
load a media player at a client;
display, within a user interface, a plurality of display portions, wherein each display portion is associated with one of the identified media files; and
play selected ones of the identified media files using the loaded media player.

12. The apparatus of claim 11, wherein the processor is operable to play selected ones of the identified media files by:
receive input from the user;
adjust a location of a cursor within the user interface based on the input;
determine whether the user has moved the cursor into a first display portion of the user interface; and
initiate display of a media file within the first portion in response to determining that the user has moved the cursor into the first portion.

13. The apparatus of claim 12, wherein the processor is operable to initiate display of the media file within the first portion in response to determining that the user has moved the cursor into the first portion comprises initiating display of the media file within the first portion in response to determining that the user has moved the cursor into the first portion and without receiving a selection input from the user.

14. The apparatus of claim 13, wherein the processor is operable to:
receive input from a user comprises receiving input from an input device comprising a device button operable to transmit a selection input; and
initiate display of the media file without receiving a selection input from the user comprises initiating display of a media file without detecting a click of the device button.

15. The apparatus of claim 12, wherein the processor is further operable to:
receive additional input from the user;
adjust the position of the cursor based on the additional input;
determine whether the user has moved the cursor out of the first portion of the user interface; and
in response to determining that the user has moved the cursor out of the first portion of the user interface, terminate display of the media file.

16. The apparatus of claim 12, wherein the media file comprises a first media file, and wherein the processor is further operable to:
receive additional input from the user, wherein the additional input includes information instructing the client to continue playing the first media file;
adjust the position of the cursor based on the additional input;
determine whether the user has moved the cursor into a second portion of the user interface; and
while continuing to display the first media file in the first portion of the user interface, display a second media file within the second portion in response to determining that the user has moved the cursor into the second portion.

17. The apparatus of claim 11, wherein each of the display portions comprises a thumbnail representation of a portion of a media file associated with that display portion.

18. The apparatus of claim 11, wherein the media files comprise motion imagery.

19. The apparatus of claim 11, wherein the media files comprise audio information.

20. The apparatus of claim 11, wherein the processor is further operable to:
receive search criteria by receiving one or more search keywords; and
identify a plurality of media files by identifying a plurality of media files associated with the search keywords.

21. Logic embodied in a computer readable medium, the computer readable medium comprising code operable, when executed, to:
receive search criteria from a user;
identify a plurality of media files corresponding to the search criteria;
load a media player at a client;
display, within a user interface, a plurality of display portions, wherein each display portion is associated with one of the identified media files; and
play selected ones of the identified media files using the loaded media player.

22. The logic of claim 21, wherein the code is operable to play selected ones of the identified media files by:
receiving input from the user;
adjusting a location of a cursor within the user interface based on the input;
determining whether the user has moved the cursor into a first display portion of the user interface; and
initiating display of a media file within the first portion in response to determining that the user has moved the cursor into the first portion.

23. The logic of claim 22, wherein the code is operable to initiate display of the media file within the first portion in response to determining that the user has moved the cursor into the first portion by initiating display of the media file within the first portion in response to determining that the user has moved the cursor into the first portion and without receiving a selection input from the user.

24. The logic of claim 23, wherein the code is operable to:
receive input from a user by receiving input from an input device comprising a device button operable to transmit a selection input; and
initiate display of the media file without receiving a selection input from the user by initiating display of a media file without detecting a click of the device button.

25. The logic of claim 22, wherein the logic is further operable too:
receive additional input from the user;
adjust the position of the cursor based on the additional input;
determine whether the user has moved the cursor out of the first portion of the user interface; and
in response to determining that the user has moved the cursor out of the first portion of the user interface, terminate display of the media file.

26. The logic of claim 22, wherein the media file comprises a first media file, and wherein the code is further operable to:
receive additional input from the user, wherein the additional input includes information instructing the client to continue playing the first media file;
adjust the position of the cursor based on the additional input;
determine whether the user has moved the cursor into a second portion of the user interface; and
while continuing to display the first media file in the first portion of the user interface, display a second media file within the second portion in response to determining that the user has moved the cursor into the second portion.

27. The logic of claim 21, wherein each of the display portions comprises a thumbnail representation of a portion of a media file associated with that display portion.

28. The logic of claim 21, wherein the media files comprise motion imagery.

29. The logic of claim 21, wherein the media files comprise audio information.

30. The logic of claim 21, wherein the code is operable to:
receive search criteria by receiving one or more search keywords; and
identify a plurality of media files by identifying a plurality of media files associated with the search keywords.

31. A system for displaying information, comprising:
means for receiving search criteria from a user;
means for identifying a plurality of media files corresponding to the search criteria;
means for loading a media player at a client;
means for displaying, within a user interface, a plurality of display portions, wherein each display portion is associated with one of the identified media files; and
means for playing selected ones of the identified media files using the loaded media player.
